(19) United States
(12) Patent Application Publication
(10) Pub. No.: US 2007/0000586 A1
(43) Pub. Date: Jan. 4, 2007

(54) Assemblies comprising an insert allowing flat running

(75) Inventors: Philippe Tramond, St-Ours-Les-Roches (FR); Martial Fayol, Volvic (FR); Michel Gobert, Clermont-Ferrand (FR); Georges Peyron, Riom (FR)

Correspondence Address: COHEN, PONTANI, LIEBERMAN & PAVANE, 551 FIFTH AVENUE, SUITE 1210, NEW YORK, NY, 10176, US

(73) Assignee: Michelin Recherche et Technique S.A., Granges-Paccot (CH)

(21) Appl. No.: 11/478,785

(22) Filed: Jun. 30, 2006

(30) Foreign Application Priority Data
Jun. 30, 2005 (FR) 05/06753

(51) Int. Cl. B60C 17/06

(52) U.S. Cl. 152/158; 152/520; 152/339.1

(57) ABSTRACT

A system (1′) formed of a wheel comprising a rim (3′) equipped with an inflation valve (4′), a tire (2′) mounted on said rim of said wheel, and an airtight cellular foam insert (5′) placed inside the volume defined by the internal wall of the tire (2′) and the rim of the wheel (3′). The foam insert (5′) is disposed in a first compartment (A), in communication with the atmosphere via a duct (44′, 46′), and isolated from the rest of the space inside the tire casing by a device (302′) ensuring the airtight seal between the wall of said first compartment (A) and an element of the internal wall of the rim or the casing, in such a way as to form a second airtight compartment (B) communicating with the inflation valve (4′) and inflated to tire utilisation pressure. The duct for providing communication with the atmosphere (44′, 46′) is equipped with a closing device (45′) which adopts the closed position during travel and is capable of being brought into the open position between two travel phases.

### FIELD OF THE INVENTION

The invention relates to run flat systems intended to be fitted on motor vehicles. These systems comprise a rim equipped with a valve and a tire, and enclose an insert approximately toroidal in shape. This insert, more commonly known as a foam insert, is generally made of closed-cell cellular rubber. It is designed to bear the load in the event of the tire losing pressure. The cells may, in some cases, contain a pressurised gas.

### BACKGROUND OF THE INVENTION

Safety devices of this type are known from the prior art and numerous variant embodiments have been proposed. One of them is disclosed in patent FR 1 450 638, which explains the operating principle thereof and describes the behaviour of the insert under the effect of centrifugal force. This publication proposes to improve the stability of the foam insert on the rim, and to bring the radially inner face of the insert into contact with atmospheric pressure, while the inflation pressure acts on the radially outer face of this insert.

In order to achieve this effect, it is proposed to place an airtight annular membrane, or alternatively an airtight film, at the intermediate point between each of the sidewalls of the insert and the internal wall of each of the beads of the tire casing in order to create a first compartment in communication with the atmosphere and a second, pressurised compartment.

The difference in pressure between the two compartments produces a radially inwardly directed centripetal force acting on the insert and having the effect of flattening said insert on the rim by compressing the gas contained in the cells. The action of the inflation pressure also has the consequence of reducing the volume of said insert, which makes it possible to avoid all contact between the internal wall of the tire and the foam insert. This force also opposes the centrifugal force and assists in holding the insert in position against the rim when the vehicle reaches an elevated speed.

When the pressure in the tire casing falls below a certain threshold, the foam insert resumes its natural shape and occupies all the internal volume of the tire casing, so contributing to support of the tire.

This same patent also describes a particular embodiment of the valve which is designed so as to allow the first compartment to communicate with the atmosphere and the second compartment to be inflated to tire utilisation pressure.

However, this first proposal may prove insufficient when it is wished to increase vehicle speed. To this end, an improvement directed towards modifying anchorage of the foam insert on the rim is described in patent EP 314 988. The solution consists in modifying the profile of the rim by creating a groove whose lateral walls comprise undercuts in which the base of the foam insert is anchored through the action of pressure. In the absence of an annular membrane, an airtight seal between the compartment under pressure and the compartment at atmospheric pressure is ensured by the contact between the foam insert and projections situated on the radially outer lateral faces of the groove.

This patent also describes the arrangement in the rim of inflation orifices and orifices for connection with atmospheric pressure.

The two solutions described in the above-cited patents provide certain improvements with regard to holding the foam insert flattened against the rim during travel but have still proven insufficient when it is desired once again to raise the speed threshold beyond which the foam insert loses contact with the rim under the effect of centrifugal forces.

### SUMMARY OF THE INVENTION

It is an object of the present invention to propose an improvement to systems such as those described above and comprising:

a wheel comprising a rim equipped with a valve,

a tire mounted on the rim of said wheel and

a foam insert placed inside the volume defined by the internal wall of the tire and the rim of the wheel, in which the foam insert is disposed in a first compartment (A) in communication with the atmosphere via a duct and isolated from the rest of the space inside the tire casing by a device ensuring an airtight seal between the wall of said compartment and an element of the internal wall of the rim or of the casing, so as to form a second airtight compartment (B) communicating with the inflation valve and inflated to the utilisation pressure of the tire.

It has been demonstrated that, by closing off said duct connecting the first compartment A with the atmosphere during travel, it is possible to increase the threshold speed beyond which the base of the foam insert, subject to the effects of centrifugal force, is liable to become detached from the rim and to come into contact with the inner part of the crown of the tire.

In effect, by preventing atmospheric air from penetrating into the first compartment when the foam insert is subjected to the action of centrifugal forces, this compartment is deprived of the possibility of increasing its volume without causing a reduction in the pressure within it. This reduction in the pressure applied to the surface of the foam insert increases accordingly the effect of flattening the base of the insert against the radially inner part of the rim in the manner of a suction cup applied to the surface of a wall. Limiting the amount the base of the foam insert may move away makes it possible to avoid detachment of the foam insert from the rim under the action of centrifugal force, which would be liable to cause instability.

This suction cup effect is in addition to the inflation pressure and improves accordingly the maintenance of contact between the foam insert and the rim. The elimination of this component has the effect of reducing the weight of the system accordingly and improving the comfort and behaviour of the vehicle while reducing the detrimental effects associated with a non-suspended mass.

It will likewise be noted that it remains important to be able to bring the first compartment into contact with the atmosphere between two phases of travel so as to allow the gases to escape which are liable to enter the first compartment and which originate from the foam insert itself when the latter comprises cells filled with pressurised gas which may have tendency to release some of this gas.

It is also an object of the invention to propose particular embodiments of the device which allow the duct connecting said first compartment to the atmosphere to be closed off during travel. This closing device may be activated manually or during travel under the effect of centrifugal force.

### BRIEF DESCRIPTION OF THE DRAWINGS

In order better to understand the invention, FIGS. 1 to 6 have the purpose of illustrating embodiments of the device for closing off the duct for bringing said first compartment into communication with the atmosphere which are adapted to the systems disclosed in patents FR 1 450 638 and EP 314 988.

FIG. 1 is a schematic sectional view of a system as described in patent FR 1 450 638,

FIGS. 2 and 3 are schematic sectional views of a valve equipped with a rotary collar,

FIGS. 4 and 5 are schematic sectional views of a valve equipped with a mobile check valve,

FIG. 6 is a schematic sectional view of a closing device with mobile check valve incorporated in a rim such as described in patent EP 314 988.

### DETAILED DESCRIPTION OF THE DRAWINGS

Elements which are identical or of similar nature are designated with the same reference numerals.

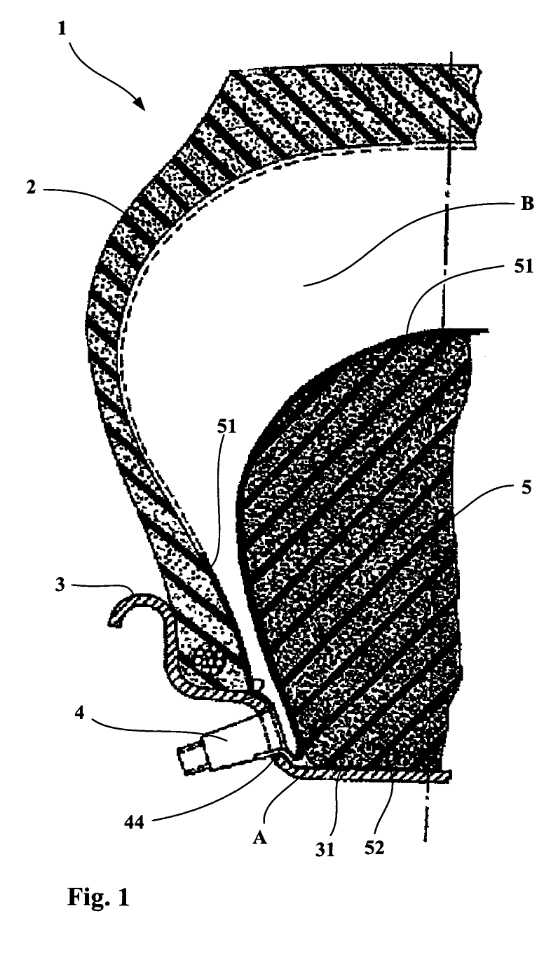

FIG. 1 is a schematic view of a system 1 comprising a tire 2 mounted on a rim 3 comprising a valve 4. A foam insert 5 is placed inside the space formed by the rim and the inner part of the tire. An airtight film 51 is disposed around the entire radially outer circumference of the foam insert and is extended in order to adhere to the internal wall of the bead of the tire, with which it forms an airtight joint. The base 52 of the foam insert rests on the radially inner part 31 of the rim 3.

This film defines two compartments, the first (A) of which, is situated in the space between the rim and the radially inner wall of the film 51, and the second (B) of which is situated between the internal wall of the tire and the radially outer wall of said film.

The first compartment A encloses the foam insert 5 and communicates with the atmosphere via a channel 44 formed in the valve 4. The second compartment B may be brought to the utilisation pressure of the tire by means of the main duct of the valve 4.

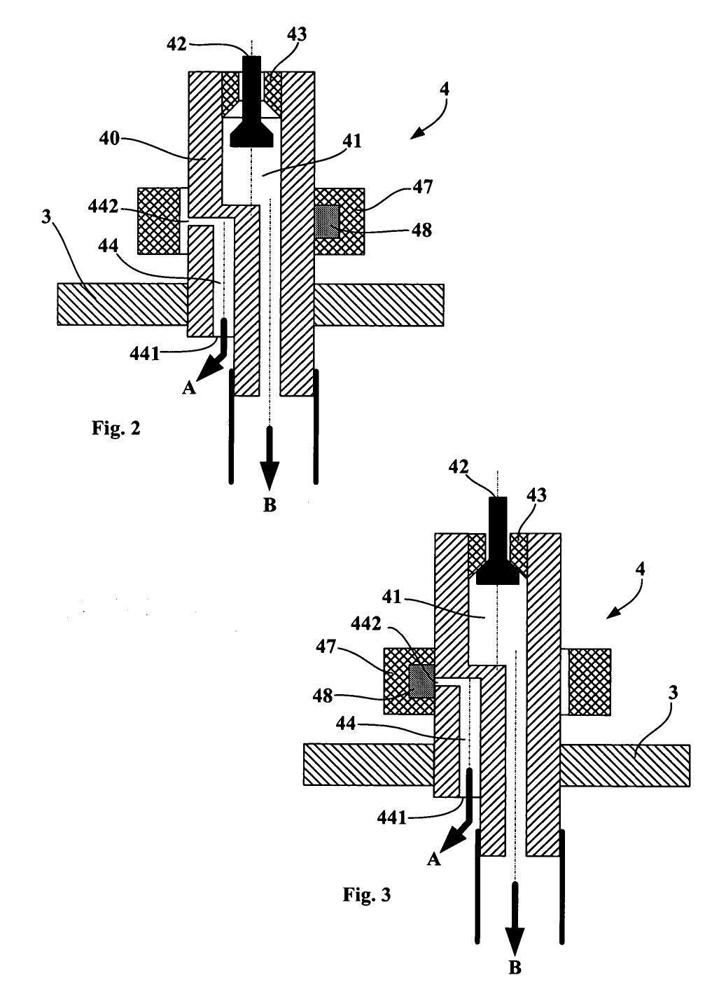

FIGS. 2, 3, 4 and 5 illustrate in detail particular embodiments of the inflation valve 4 allowing a system to be produced in accordance with the invention on the basis of an assembly like that described above.

FIG. 2 describes in schematic view a valve 4 mounted on a rim 3. The valve is formed of a body 40 comprising a duct 41 closed off from the outside by a mobile check valve 42 resting on its seat 43. The duct 41 communicates with the second compartment B and, by detaching the check valve from its seat, it is possible to inflate the second compartment B via the duct 41.

The valve also comprises on one of its sides a duct 44, one of whose orifices 441 communicates with the first compartment A, and whose second orifice 442 may be brought into communication with the atmosphere. A rotary ring 47, comprising an airtight seal 48, is manoeuvrable into a first position in which the gases are allowed to circulate freely, as illustrated in FIG. 2, and into a second position in which the orifice 442 is closed off, as illustrated in FIG. 3.

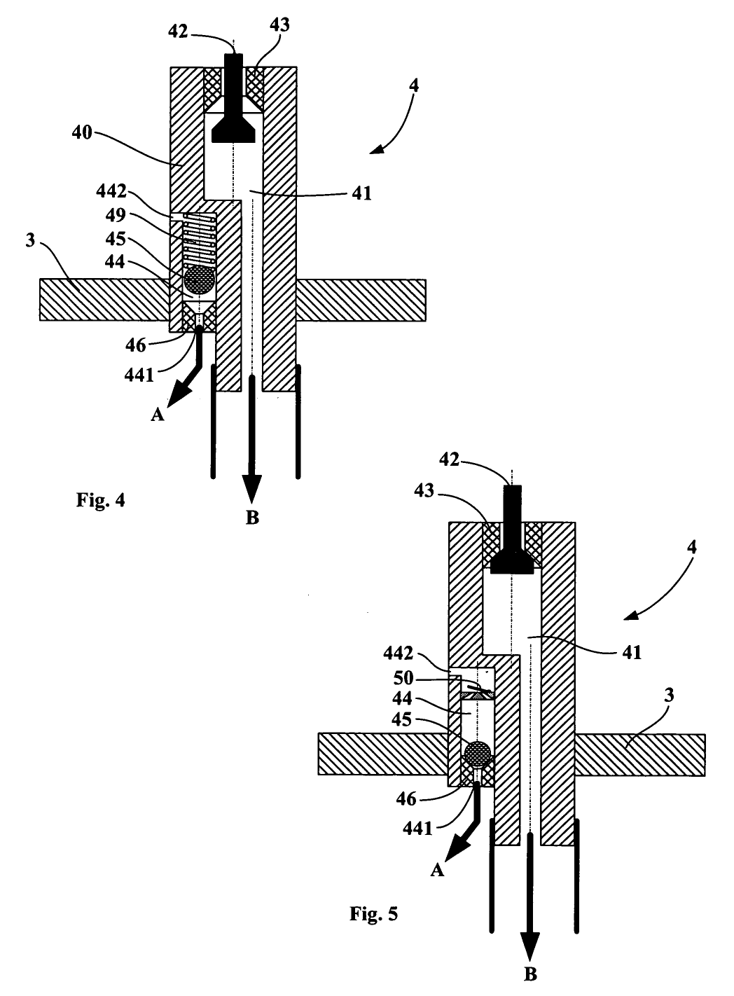

FIGS. 4 and 5 show an alternative embodiment in which the duct 44 comprises, at the part of the orifice 441 leading towards the first compartment A, a seat 46 on which a mobile check valve 45 comes to bear. The mobile check valve substantially takes the form of a ball. Under the action of centrifugal force the ball is driven against the seat 46 and in this way closes off the duct 44 in airtight manner. When the vehicle is at a standstill, the ball detaches itself from the seat under the action of the forces of gravity.

By positioning a spring 49 as shown in FIG. 4, the action of which has the effect of forcing the ball against its seat 46, it becomes possible for the first compartment A to come into contact with the outside air only when the pressure inside said compartment is greater than a calibration pressure which is known and greater than atmospheric pressure.

Conversely, by positioning said spring (not shown), or its equivalent, between the ball 45 and the seat 46, it is possible to reduce the force necessary to detach the ball and to promote communication between the first compartment A and the outside air whatever the position of the wheel when at a standstill.

Likewise, by arranging a nonreturn valve 50, as illustrated diagrammatically in FIG. 5, at the level of the duct 44, communication between the first compartment A and the outside air is allowed only when the pressure inside the latter is greater than atmospheric pressure. This check valve 50 must be positioned so as not to hinder movement of the ball 45.

It is also possible to position the seat 46 at the other end of the duct 44 if the configuration with regard to mounting the valve on the rim tends to reverse the action of centrifugal force on the ball.

Thus, the two examples of embodiment described above make it possible to close off in airtight manner the duct 44 bringing the first compartment A into communication with the atmosphere. In the first embodiment it is necessary to manoeuvre a revolving ring between two travel phases, whilst the effect of centrifugal force and gravity alone makes it possible to fulfil the desired functions without involving the user in the case of the second embodiment described above.

It is of course possible to imagine equivalent devices, such as ducts for providing communication with the outside air placed at locations separate from the mounting point of the inflation valve and bringing the first compartment A into communication with the outside air.

In all cases, it must be ensured that the orifice 442 is positioned in such a way that external substances such as mud, dust or rainwater cannot enter via this orifice into the first compartment A. A first solution consists in moving it away from the outer surface of the rim 3 sufficiently to prevent substances which become deposited thereon from reaching the orifice 442. Another solution consists in protecting the orifice by a ring of the type designated 47 and described above, said ring being without closing means such as an airtight seal 48.

Although not shown in the Figures, these devices may equally well be closed off by a manually opened and closed stopper or by a rotary ring similar to that to which the present description relates, these two devices being manoeuvred manually by the user between two travel phases, or by a device comprising a mobile check valve equivalent to that also described above.

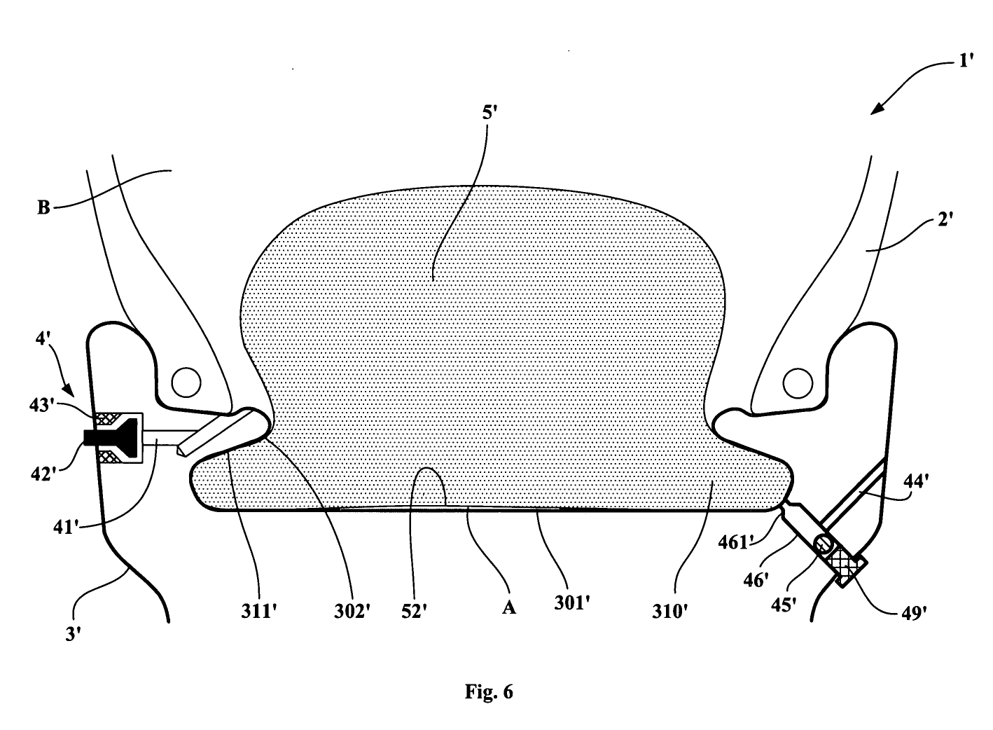

FIG. 6 illustrates an embodiment of the invention relating to the rim as described in publication EP 314 988, in which the system 1′ comprises a tire 2′ mounted on a rim 3′. Said rim 3′ comprises a groove 310′ designed to receive a foam insert 5′. The groove 310′, whose meridian section takes the form substantially of a “U” whose concavity is oriented radially to the outside, the base of said “U” constituting the bottom 301′ of the groove being approximately parallel to the axis of rotation of the system 1′, is defined axially on either side by lateral walls 302′ extending radially towards the outside relative to the bottom 301′ of the groove 310′. An orifice (46′, 44′) for contact with the outside air designed to provide communication with atmospheric pressure is provided in said groove 310′. The lateral walls 302′ each comprise at least one undercut 311′. Said orifice (46′, 44′) for contact with the outside air is situated radially towards the outside relative to the undercuts 311′ and on each of said lateral walls 302′, such that, by dimensional retraction resulting from inflation during mounting, the insert 5′ adopts its final configuration and position in the undercuts 311′ provided on the rim.

By ensuring that the outer surface of the foam insert 5′ is covered with an airtight material, the first compartment A is defined by the base 301′ of the groove 310′ and by the wall of the foam insert situated radially towards the inside and defined by the airtight contact formed between the foam insert 5′ and the lateral walls 302′ of the groove 310′. Compartment B is contained between the inner wall of the tire 2′ and the wall of the foam insert 5′ situated radially to the outside of the sealing points.

The base 52′ of the foam insert 5′ rests on the radially inner part 301′ corresponding to the base of the groove 310′ of the rim 3′.

The duct for bringing the first compartment into communication with the outside air comprises a first duct 46′ whose orifice 461′, opening into the first compartment A, takes the form of a seat on which a mobile check valve 45′ comes to bear. A stopper 49′ ensures permanent closure of the other end of the duct 46′. A second duct 44′ brings the duct 46′ into communication with the outside air. As has already been illustrated with reference to the previous example of embodiment, the mobile check valve 45′ has substantially the form of a ball. The orifice 44′ is oriented radially towards the outside, so as to promote evacuation of any external foreign substances under the action of centrifugal forces during travel.

The centrifugal force also drives the ball 45′ against the seat 461′, which has the effect of closing off the duct 46′. When the vehicle is at a standstill, the ball 45′ detaches itself from the seat 461′ solely under the action of the force of gravity, and opens a path of communication between the first compartment A and the outside air.

Inflation of the compartment B is effected in known manner through the intermediary of a valve 4′ connected to the duct 41′ and whose orifice leading to the outside air is closed off after inflation by the mobile check valve 42′ resting on the seat 43′. In order to promote the evacuation of air and the airtight engagement of the sidewall of the foam insert with said lateral walls 302′, it is sometimes desirable to provide a means of bringing the first compartment A into communication with the outside air at the level of each of the undercuts 311′ situated axially on either side of the rim 3′.

Implementation of the devices according to the invention in systems such as those described above has made it possible to improve running performance at high speed. Thus, for a system of the type described in publication FR 1 450 638, it has been possible to increase by approximately 25 km/h the threshold beyond which the base (52, 52′) of the foam insert comes off the rim (31, 301′).

It will be noted that the effect described above may be improved by modifying in a favourable direction the design features of the system, and in particular the contact surface between the rim and the foam insert, by acting for example on the width of the rim.

We claim:

1. A system (1, 1′) formed of a wheel, comprising:
a rim (3, 3′) equipped with an inflation valve (4, 4′);
a tire (2, 2′) mounted on said rim of said wheel; and
a foam insert (5, 5′) placed inside a volume defined by an internal wall of the tire (2, 2′) and the rim (3, 3′) of the wheel, wherein the foam insert (5, 5′) is disposed in a first compartment (A), in communication with the atmosphere via a duct (44, 44′, 46′) and isolated from the rest of the space inside the tire casing by means (51, 302′) ensuring an airtight seal between the wall of said first compartment (A) and an element of the internal wall of the rim or the casing, in such a way as to form a second airtight compartment (B) communicating with the inflation valve (4, 4′) and inflated to tire utilisation pressure,
wherein said duct for providing communication with the atmosphere (44, 44′, 46′) is equipped with a closing device (45, 45′, 47, 48) which adopts the closed position during travel and is capable of being brought into the open position between two travel phases.

2. The system according to claim 1, in which the device for closing the duct (44) for communication with the atmosphere takes the form of a manually manoeuvrable obturator (47, 48).

3. The system according to claim 2, in which the device for closing the duct (44) for communication with the atmosphere comprises a rotary ring (47, 48).

4. The system according to claim 2, in which the device for closing the duct (44) for communication with the atmosphere takes the form of an airtight stopper.

5. The system according to claim 1, in which the device for closing the duct for communication with the atmosphere (44, 44′, 46′) takes the form of a mobile check valve (45, 45′).

6. The system according to claim 5, in which the mobile check valve (45, 45′) closes off the duct for communication with the atmosphere (44, 46′) under the action of centrifugal force when said system is set in rotation.

7. The system according to claim 6, in which the mobile check valve (45, 45′) is provided with a calibrating spring (49) whose action has the effect of forcing the mobile check valve back against its seat (46).

8. The system according to claim 6, in which a nonreturn valve is placed at the level of the duct (44) for communication with the atmosphere, allowing the first compartment A to communicate with the outside air solely when the pressure inside it is greater than atmospheric pressure.

9. The system according to claim 1, in which the duct for communication with the atmosphere (44) is incorporated into the inflation valve (4).

10. The system according to claim 1, in which the pressure in the first compartment A diminishes under the action of centrifugal force.

11. The system according to claim 10, in which a reduction in pressure in the first compartment has the effect of limiting the distance between the base (52, 52′) of the foam insert (5, 5′) and the radially inner part (31, 301′) of the rim (3, 3′).
